(19) United States
(12) Patent Application Publication
(10) Pub. No.: US 2015/0090235 A1
(43) Pub. Date: Apr. 2, 2015

(54) CPV-CONTROLLED EVAP LEAK DETECTION SYSTEM

(71) Applicant: Ford Global Technologies, LLC, Dearborn, MI (US)

(72) Inventors: RUSSELL RANDALL PEARCE, ANN ARBOR, MI (US); AED M. DUDAR, CANTON, MI (US)

(73) Assignee: Ford Global Technologies, LLC, Dearborn, MI (US)

(21) Appl. No.: 14/042,966

(22) Filed: Oct. 1, 2013

(51) Int. Cl. F02M 25/08

(52) U.S. Cl. CPC F02M 25/0854
USPC 123/520

(57) ABSTRACT

A method and system for testing an evaporative emission control system for leaks. The method includes opening a canister purge valve by an amount sufficient to provide a flow equivalent to a predetermined orifice diameter. Then, a vacuum pump evacuates a reference volume consisting of the portion of the evaporative emission control system extending from the canister purge valve to an evacuation level control monitor. The system determines the pressure in the reference volume at the end of a specified evacuation time, and that value is stored as the threshold test value. Then, the system closes the canister purge valve and proceeds to evacuate the entire evaporative emission control system for a predetermined time. At the end of that time, the system identifies the absence of a leak if the system pressure falls at least to the threshold test value. A powertrain control module controls the canister purge valve.

### TECHNICAL FIELD

Embodiments of the present disclosure generally relate to Evaporative Emission Control Systems (EVAP) for automotive vehicles, and, more specifically, to detecting leaks within EVAP systems.

### BACKGROUND

Gasoline, the fuel for many automotive vehicles, is a volatile liquid subject to potentially rapid evaporation, in response to diurnal variations in the ambient temperature. Thus, the fuel contained in automobile gas tanks presents a major source of potential emission of hydrocarbons into the atmosphere. Such emissions from vehicles are termed ‘evaporative emissions’, and those vapors can be emitted vapors even when the engine is not running

In response to this problem, industry has incorporated evaporative emission control systems (EVAP) into automobiles, to prevent fuel vapor from being discharged into the atmosphere. EVAP systems include a canister (the carbon canister) containing adsorbent carbon) that traps fuel vapor. Periodically, a purge cycle feeds the captured vapor to the intake manifold for combustion, thus reducing evaporative emissions.

Hybrid electric vehicles, including plug-in hybrid electric vehicles (HEV's or PHEV's), pose a particular problem for effectively controlling evaporative emissions. Although hybrid vehicles have been proposed and introduced in a number of forms, these designs all provide a combustion engine as backup to an electric motor. Primary power is provided by the electric motor, and careful attention to charging cycles can produce an operating profile in which the engine is only run for short periods. Systems in which the engine is only operated once or twice every few weeks are not uncommon. Purging the carbon canister can only occur when the engine is running, of course, and if the canister is not purged, the carbon pellets can become saturated, after which hydrocarbons will escape to the atmosphere, causing pollution.

EVAP systems are generally sealed to prevent the escape of any hydrocarbons. These systems require periodic leak detection tests to identify potential problems.

A requirement for leak testing, of course, is a standard against which to measure. In general, leak standards are expressed in terms of the maximum allowable orifice size. This field is relatively new, however, and regulatory bodies often change standards, requiring adaptation of standard leak detection procedures. Such changes often necessitate modifications in the measuring equipment, which imposes higher costs. One aspect under considerable discussion is the maximum allowable orifice size—that is, size limit for the largest allowable leak. Commonly used test equipment provides a reference orifice to establish a reference pressure level and thus any change in the maximum allowable orifice size would require changes in the reference orifice as well.

Understandably, changes to test systems, such as modifications to the orifice size, exact a toll on the manufacturers and service providers. This leaves alternatives to accommodate multiple orifices or attempts to determine the reference pressure efficiently during EVAP leak tests substantially unchallenged.

### SUMMARY

One aspect of the present disclosure describes a method for testing an evaporative emission control system for leaks. The method includes opening a canister purge valve by an amount sufficient to provide a flow equivalent to a predetermined orifice diameter. Then, a vacuum pump evacuates a reference volume consisting of the portion of the evaporative emission control system extending from the canister purge valve to an evacuation level control monitor. The system determines the pressure in the reference volume at the end of a specified evacuation time, and that value is stored as the threshold test value. Then, the system closes the canister purge valve and proceeds to evacuate the entire evaporative emission control system for a predetermined time. At the end of that time, the system identifies the absence of a leak if the system pressure falls at least to the threshold test value.

Another aspect of the disclosure is an improvement upon and evaporative emission control system. Here, the evaporative emission control system is controlled by a Powertrain Control Module, and it further includes a fuel tank in fluid communication with a carbon canister, the carbon canister in turn being in fluid communication with an engine intake manifold. The improvement is found in the fact that the control system includes a leak detection system. The leak detection system includes a vacuum pump having a first port in fluid communication with an ambient atmosphere, and a second port in fluid communication with the evaporative emission control system. Further, a canister purge valve (CPV) is positioned in a fluid communication line between the canister and the intake manifold, operably connected to the PCM. The PCM is configured to control the CPV to open the CPV by an amount sufficient to provide a flow equivalent to a predetermined orifice diameter.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1A is a schematic view of an exemplary EVAP system installed in a PHEV, incorporated with a conventional ELCM.

FIGS. 1B, 1C, and 1D, are schematics describing the working of an exemplary ELCM.

FIG. 2 is a schematic of a CPV-controlled EVAP leak detection system according to the present disclosure.

FIG. 3 is a flowchart illustrating an exemplary method to carry out an EVAP leak diagnosis in vehicles, according to the present disclosure.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes a method for determining EVAP leaks in PHEVs via a variably configured orifice arrangement. To this end, a canister purge valve (CPV) is configured so that a technician can dial-in a required orifice or a passage size. In response, the CPV replicates a conventional orifice corresponding that dialed-in size. Leak tests commence thereafter.

### Exemplary Embodiments

The following detailed description illustrates aspects of the disclosure and its implementation. This description should not be understood as defining or limiting the scope of the present disclosure, however, such definition or limitation being solely contained in the claims appended hereto. Although the best mode of carrying out the invention has been disclosed, those in the art would recognize that other embodiments for carrying out or practicing the invention are also possible.

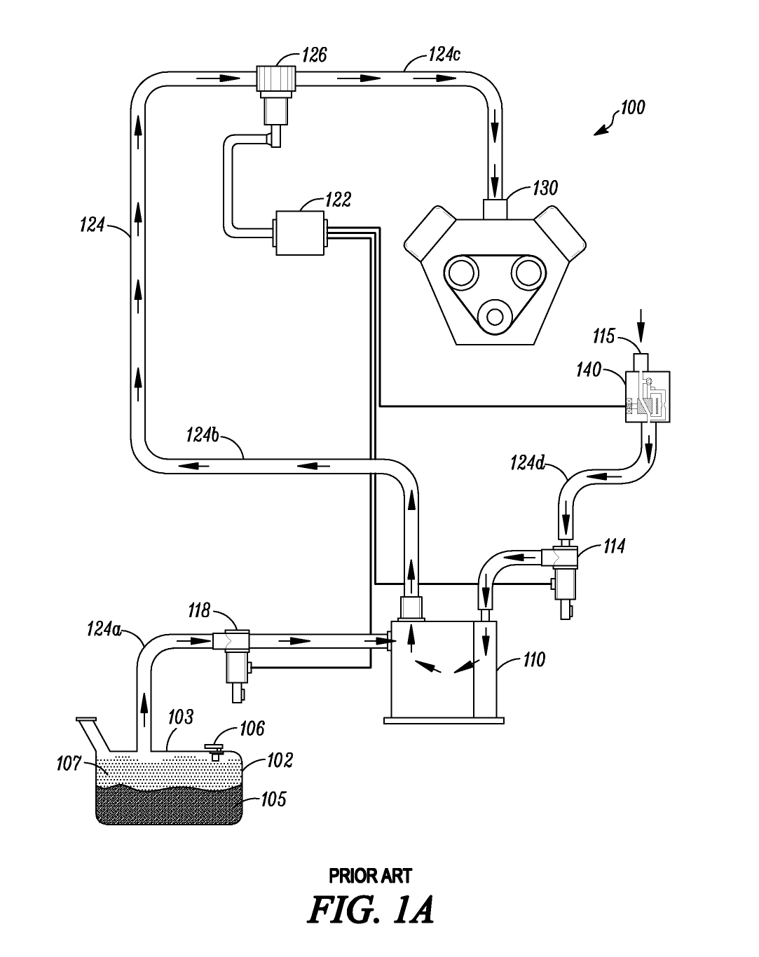

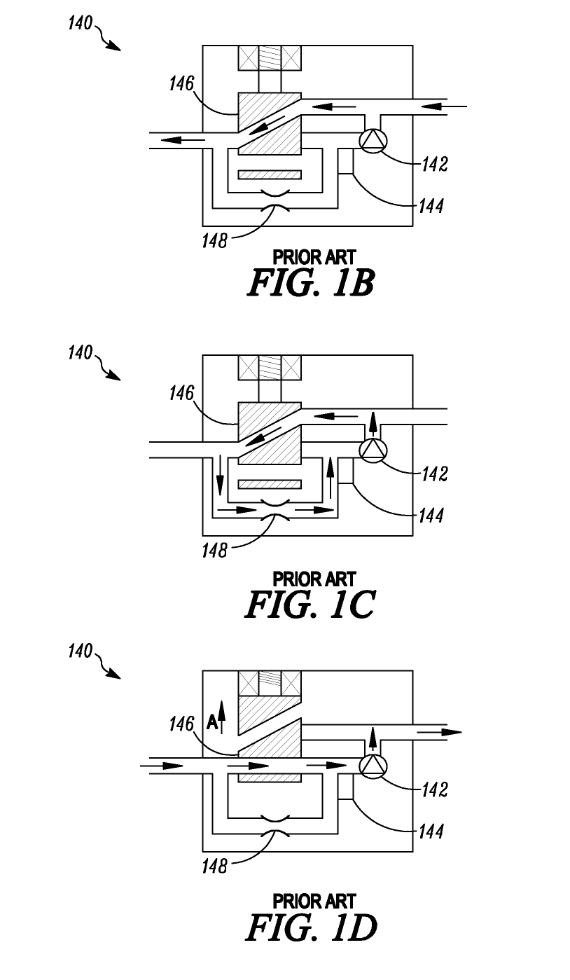

FIG. 1A illustrates a conventional evaporative emissions control system 100. As seen there, the system 100 is made up primarily of the fuel tank 102, a carbon canister 110, and the engine intake manifold 130, all operably connected by lines and valves.105. It will be understood that many variations on this busy design are possible, but the illustrated embodiment follows the general practice of the art. It will be understood that the system 100 is generally sealed, with no open vent to atmosphere.

Fuel tank 102 is partially filled with liquid fuel 105, but a portion of the liquid evaporates over time, producing fuel vapor 107 in the upper portion (or “vapor dome 103”) of the tank. The amount of vapor produced will depend upon a number of environmental variables, such as the ambient temperature. Of these factors, temperature is probably the most important, given the temperature variation produced in the typical diurnal temperature cycle. For vehicles in a sunny climate, particularly a hot, sunny climate, the heat produced by leaving a vehicle standing in direct sunlight can produce very high pressure within the vapor dome 103 of the tank 102. A fuel tank pressure transducer (FTPT) 106 monitors the pressure in the fuel tank vapor dome 103.

Vapor lines 124 operably join various components of the system. One, line 124a, runs from the fuel tank 102 to carbon canister 110. A normally closed fuel tank isolation valve (FTIV) 118 regulates the flow of vapor from fuel tank 102 to the carbon canister 110, so that flows normally freely permitted, so that the carbon pellets can adsorb the vapor generated by evaporating fuel. Vapor line 124b joins line 124a in a T intersection beyond FTIV 118, connecting that line with a normally closed canister purge valve (CPV) 126. Line 124c continues from CPV 126 to the engine intake manifold 130. CPV 126 is controlled by signals from the powertrain control module (PCM) 122, which also controls FTIV 118.

Canister 110 is connected to ambient atmosphere at vent 115, through a normally closed canister vent valve (CPV) 114. Vapor line 124d connects that 115 in canister 110.

Powertrain Control Module (PCM 122) may include a controller (not shown) of a known type connected both sensors, such as FTPT 106, as well as active control components, such as CCV 114. Connections may carry to other sensors as well. The controller may be of a known type, forming one part of the hardware of the said system, and may be a microprocessor based device that includes a central processing unit (CPU) for processing incoming signals from known source. The controller may be provided with volatile memory units, such as a RAM and/or ROM that function along with associated input and output buses. Further, the controller may also be optionally configured as an application specific integrated circuit, or may be formed through other logic devices that are well known to the skilled in the art. More particularly, the controller may be formed either as a portion of an existing electronic controller, or may be configured as a stand-alone entity.

During normal operation, FTIV 118, CPV 126, and CVV 114 are all closed. That configuration retains vapor within the fuel tank 102. Periodically, FTIV 118 is opened, allowing vapor to flow into canister 110. There, carbon pellets can adsorb fuel vapor.

To purge the canister 110, FTIV 118 is closed, and valves 126 and 114 are opened. It should be understood that this operation is only performed when the engine is running, which produces a vacuum at intake manifold 130. That vacuum causes an airflow from ambient atmosphere through vent 115, canister 110, and CPV 126, and then onward into the intake manifold 130. As the airflow passes through canister 110, it entrains fuel vapor from the carbon pellets. The fuel vapor mixture then proceeds to the engine, where it is mixed with the primary fuel/air flow to the engine for combustion.

Evacuation Level Check Monitor (ELCM) 140, is typically installed near the vent 115, and is operably connected to the PCM 122. Other arrangements may be contemplated. ELCM 140 can be a component available and known to the art for performing EVAP leak checks, such as the ELCM manufactured by Denso Corporation™. A detailed ELCM layout and working principle is set out in FIGS. 1B, 1C, and 1D. That layout includes a vacuum pump 142, an absolute pressure sensor 144, a Changeover Valve (COV 146), and a reference orifice 148. Vacuum pump 142 evacuates the EVAP system for leak testing, under control of PCM 122.

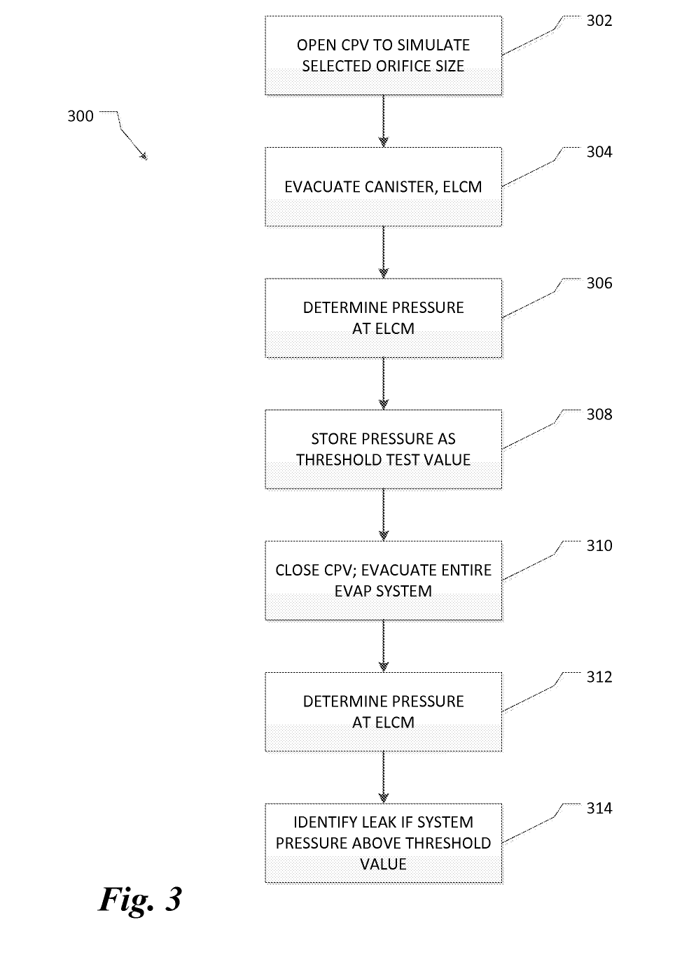

FIGS. 1B, 1C, and 1D schematically illustrate COV 146. This device includes two input/output connections. The first connects to fluid communication line 124d, which runs to canister 110. A second connection provides a vent to atmosphere through system vent 115. Within the device, three possible airflow paths are provided, as selected by a solenoid 302. That device has a solenoid body 301, a generally cylindrical body having two flow paths formed through it: a vertically oblique path and a horizontal path. Solenoid 302 moves between a de-energized position, illustrated in FIG. 1B, in which solenoid body 301 extends to a maximum extent downward into ELCM 140, and an energized position, seen in FIG. 3B. In the latter position, solenoid body 301 is drawn upward toward the windings of solenoid 302.

Of the flow paths within ELCM 140, airflow path 111a extends from a position adjacent solenoid 302 to system vent 310. This airflow path is positioned in alignment with one outlet of the oblique flow path when solenoid 302 is not energized.

Airflow path 111b runs from the junction with fluid communication line 318, to a junction with airflow path 111a. This flow path is interrupted by solenoid 302, and the ends thus formed in flow path 111b are positioned in alignment with the horizontal path when solenoid 302 is energized. Additionally, a three-way valve 303 is positioned in flow path 111b between solenoid 302 and the junction with path 111a. Valve 303 can be open, closed, or placed in fluid flow with pump 142.

Airflow path 111c has a general U-shape, straddling solenoid body 301, with both ends opening onto airflow path 111b on both sides of solenoid body 301. An orifice 148, having a size that can be selected to accommodate various regulatory requirements, such as 0.020″, is inserted into flow path 111c.

In the de-energized state shown in FIG. 1B, the oblique path joins flow path 111a and 111b. In a situation in which CPV 122 is closed, operation of pump 157, together with the positioning of valve 303 to connect pump 142 to flow path 111b, routes the airflow through orifice 148.

The energized state of solenoid 302, shown in FIG. 1D, pulls solenoid body 301 upward, so that the horizontal path completes the straight-through channel of path 111b. When valve 303 is open, airflow path 111b provides a ready flow path to atmosphere.

The purpose of reference orifice 148 is to simulate the effect of a leak having exactly the same size as the reference orifice. When the system is evacuated through a reference orifice, the resulting vacuum level represents the level that can be achieved with a leak having the size of the reference orifice in the system. Thus, if the maximum allowable orifice size for a given regulatory jurisdiction is 0.020″, then evacuating the system through the reference orifice will establish a reference vacuum level. As noted, frequent changes in EVAP leak regulations lead to costly modifications to standard testing procedures. Here, the orifice holds maximum potential for a change.

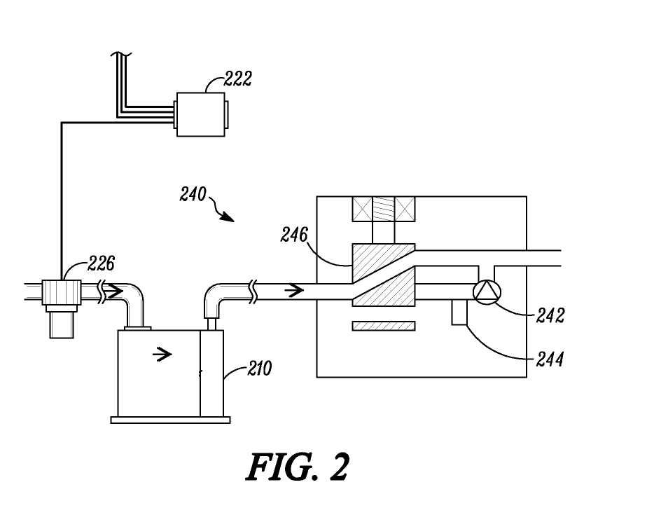

Turning to FIG. 2, an exemplary embodiment of the present disclosure in which the CPV 226 serves as a reference orifice, completely replacing the installed single-diameter reference orifice of the prior art. In this embodiment, CPV 226 is opened an amount providing a flow equivalent to that of a reference orifice. Those of skill in the art will understand how to adapt PCM 222 to control the amount by which CPV 226 is opened. In some embodiments, CPV 226 will respond to particular signal levels received from PCM 222 by opening a calibrated amount. In such embodiments, an appropriate memory structure retained in PCM 222, such as a lookup table, can provide a set of signal levels by which PCM 222 can cause CPV 226 to open to particular orifice diameters. In this manner, CPV 226 can emulate a variety of orifice sizes, tailored to particular regulatory jurisdictions. In addition, if applicable regulations change in the future, new settings can be implemented as a software change, not as a hardware replacement. Alternatively, PCM 222 can employ a servomotor, either built into that component or as a standalone device. The servomotor, operating under control of PCM 222, can open CPV 226 in the desired amount.

The illustrated embodiment is further simplified by substituting a straightforward ELCM 240. As shown, this embodiment does not require alternate, parallel, flow paths, but rather a single flow path suffices. Vacuum pump 242 is positioned to evacuate the EVAP system, with ELCM pressure sensor (ELCMPS) 244 located to conveniently measure system pressure in the vicinity of vacuum pump 242.

Operation of the component shown in FIG. 2 is best explained in conjunction with the flowchart of FIG. 3. This process begins at step 302 by opening CPV 226 a selected amount, controlled by PCM 222, as noted above.

Once CPV 226 is opened the desired amount, vacuum pump 242 evacuates the volume defined between CPV 226 and vacuum pump 242, including canister 210 and ELCM 240, at step 304. It will be immediately noted that flow through these components proceeds in a direction opposite from the flow experienced during canister purging. Therefore, leak testing must be conducted with the engine off. Evacuation continues for a predetermined time, after which ELCMPS 244 senses the pressure level (step 306), which is then forwarded to PCM 222, where it is recorded as the threshold pressure value (step 308).

Full leak testing is commenced in step 310, by closing CPV 226. At the same time, FTIV 118 and CVV 114 are opened, allowing vacuum pump 242 to evacuate the entire EVAP system. Evacuation continues for a predetermined time, sufficient to allow the complete evacuation of the EVAP system and for the vacuum level to stabilize. Typically, this operation requires about 2-15 minutes. Given the amount of time required, it will often be deemed preferable to schedule because testing for a time in which the vehicle is completely off.

At the end of the evacuation cycle, ELCMPS 244 senses the system pressure level. That value is forwarded to PCM 222, which compares it with the threshold level stored in step 308. If no leak is present, the evacuation cycle should lower the system pressure at least to the threshold test value. The failure to lower system pressure to the threshold test value indicates a leak. The system can then proceed in any suitable manner to notify the operator that EVAP system maintenance is required.

The discussed system 100 may be applied to a variety of other applications as well. For example, any similar application, requiring the adherence to stringent emission norms may make use of the disclosed subject matter. Accordingly, it may be well known to those in the art that the description of the present disclosure may be applicable to a variety of other environments as well, and thus, the environment disclosed here must be viewed as being purely exemplary in nature.

Further, the system 100 discussed so far is not limited to the disclosed embodiments alone, as those skilled in the art may ascertain multiple embodiments, variations, and alterations, to what has been described. Accordingly, none of the embodiments disclosed herein need to be viewed as being strictly restricted to the structure, configuration, and arrangement alone. Moreover, certain components described in the application may function independently of each other as well, and thus none of the implementations needs to be seen as limiting in any way.

Accordingly, those skilled in the art will understand that variations in these embodiments will naturally occur in the course of embodying the subject matter of the disclosure in specific implementations and environments. It will further be understood that such variations will fall within the scope of the disclosure. Neither those possible variations nor the specific examples disclosed above are set out to limit the scope of the disclosure. Rather, the scope of claimed subject matter is defined solely by the claims set out below.

We claim:

1. A method for testing an evaporative emission control system for leaks, comprising
opening a canister purge valve by an amount sufficient to provide a flow equivalent to a predetermined orifice diameter;
evacuating a reference volume consisting of the portion of the evaporative emission control system extending from the canister purge valve to an evacuation level control monitor;
determining a pressure in the reference volume at the end of a specified evacuation time;
storing the determined pressure as a threshold test value;
closing the canister purge valve;
evacuating the entire evaporative emission control system for a predetermined time; and
identifying the absence of a leak if, after the evacuation, the system pressure falls at least to the threshold test value.

2. The method for testing an evaporative emission control system of claim 1, wherein the opening of the canister purge valve is controlled by a Powertrain Control Module.

3. The method for testing an evaporative emission control system of claim 1, wherein a portion of the canister purge valve is machined to provide an opening equivalent to the predetermined orifice diameter.

4. The method for testing an evaporative emission control system of claim 1, wherein the predetermined orifice diameter is 0.020″.

5. The method for testing an evaporative emission control system of claim 1, wherein the evacuating is performed by a vacuum pump.

6. The method for testing an evaporative emission control system of claim 1, wherein the vacuum pump is contained within an Evacuation Level Check Monitor.

7. In an evaporative emission control system, controlled by a Powertrain Control Module and having a fuel tank in fluid communication with a carbon canister, the carbon canister being in fluid communication with an engine intake manifold, the improvement wherein the control system includes a leak detection system, comprising:
a vacuum pump having a first port in fluid communication with an ambient atmosphere, and a second port in fluid communication with the evaporative emission control system;
a canister purge valve (CPV) positioned in a fluid communication line between the canister and the intake manifold, configured operably connected to the PCM;
wherein the PCM is configured to control the CPV to open the CPV by an amount sufficient to provide a flow equivalent to a predetermined orifice diameter.
a pressure sensor configured to sense pressure of a small volume within the system, the small volume being defined by the vacuum pump, the CPV, a fuel tank isolation valve, and fluid communication lines associated with those devices; and
at least one changeover valve configured to alter fluid flow paths and directions, wherein the vacuum pump, the pressure sensor, and the at least one changeover valve constitute an Evacuation Level Check Monitor (ELCM).

8. The evaporative emission control system of claim 7, wherein a portion of the canister purge valve is machined to provide an opening equivalent to the predetermined orifice diameter.

9. The evaporative emission control system of claim 7, wherein the predetermined orifice diameter is 0.020″.

10. The evaporative emission control system of claim 7, wherein the vacuum pump is contained within an Evacuation Level Check Monitor.
